(19) United States
(12) Patent Application Publication
(10) Pub. No.: US 2023/0371484 A1
(43) Pub. Date: Nov. 23, 2023

(54) SCALLOP TRAP

(71) Applicant: FishTek Marine Limited, Totnes (GB)

(72) Inventors: Ben Kibel, Totnes (GB); Pete Kibel, Totnes (GB)

(21) Appl. No.: 18/228,063

(22) Filed: Jul. 31, 2023

Related U.S. Application Data
(63) Continuation of application No. PCT/IB2022/050755, filed on Jan. 28, 2022.

(30) Foreign Application Priority Data
Jan. 29, 2021 (GB) 2101245.5

(51) Int. Cl. A01K 69/08; A01K 80/00

(52) U.S. Cl. CPC A01K 69/08; A01K 80/00

(57) ABSTRACT

Dredging is a very destructive method of harvesting scallops as it causes significant damage to marine habitats and contaminates scallops with grit. The invention described herein provides a scallop trap comprising: a chamber having an opening; a ramp, for directing scallops to the opening, having a first portion disposed outside of the chamber and a second portion adjacent to the opening, and in use the second portion is disposed above the first portion; and an attractant disposed, in use, above the second portion of the ramp. In this way, scallops can be captured more sustainably without excessive damage to their habitat and without introducing excess grit to the scallop.

### RELATED APPLICATIONS

This application claims the benefit under 35 U.S.C. § 120, and is a continuation, of co-pending International Application PCT/IB2022/050755, filed Jan. 28, 2022 and designating the US, which claims priority to GB Application 2101245.5, filed Jan. 29, 2021, such GB Application also being claimed priority to under 35 U.S.C. § 119. These GB and International applications are incorporated by reference herein in their entireties.

### FIELD

The present invention relates generally to a scallop trap and finds particular, although not exclusive, utility in efficiently capturing scallops on the seabed without the need for harmful dredging techniques.

### BACKGROUND

Scallops are a valuable shellfish that live on a water environment's bed. More specifically, a scallop may be one of numerous species of saltwater clam or marine bivalve molluscs in the taxonomic family “Pectinidae”.

Scallops are typically harvested by dredging. Dredging is an operation that involves excavating material from a water environment, such as the sea, and can be used to recover valuable marine life, such as marine life having a commercial value. The excavation is typically undertaken by specialist floating equipment, known as a dredger, which collects material from the water environment's bed. The material from the water environments bed is then lifted above the water and sorted. The unwanted material is redeposited on the water environment's bed, often in a different place from where it was originally collected.

Dredging is a very destructive method of harvesting scallops as it causes significant damage to marine habitats by removing large parts of the water environment's bed and dumping it elsewhere. In addition, scallops caught by this method contain more grit than those caught by hand.

### SUMMARY

According to a first aspect of the present invention there is provided a scallop trap comprising a chamber, a ramp, and an attractant. The chamber having an opening. The ramp, for directing scallops to the opening, having a first portion disposed outside of the chamber and a second portion adjacent to the opening, and in use the second portion is disposed above the first portion. And, the attractant disposed, in use, above the second portion of the ramp.

In this way, scallops can be captured without introducing excess grit to the scallop. In addition, scallops can be captured more sustainably without excessive damage to their habitat. Introducing excess grit into the scallop may be otherwise be referred to as contaminating the scallop with grit.

The scallop trap may be a device or enclosure designed to catch and retain a scallop by allowing entry but not exit.

The chamber may be space or cavity. In some examples, the chamber may be a capture area that is configured to allow the entry, but not the exit of a scallop. The chamber may be defined by a perimetric wall. The perimetric wall may be configured to define a depth of the chamber. More specifically, the perimetric wall may be configured to define a depth of the chamber of at least 7 cm, at least 9 cm, at least 12 cm or at least 15 cm. Alternatively, or additionally, the perimetric wall may be configured to define a depth of the chamber of no more than 20 cm, no more than 30 cm, no more than 40 cm or no more than 50 cm. The perimetric wall may surround an area of the floor of the chamber; alternatively or additionally, the perimetric wall may enclose a volume forming the chamber. The chamber may be an enclosed space, or a cavity comprising openings exceeding a predetermined size on a limited number of surfaces. The limited number of surfaces may be only one, only two, only three, no more than two, or no more than three. The predetermined size of the openings may have a largest dimension of 1 cm, 2 cm, 3 cm, 4 cm, 5 cm, 6 cm, 7 cm, 8 cm, 9 cm or 10 cm.

The ramp may be a sloping surface joining two different levels, in use. For example, a ramp may join a first level, such as a seabed, and a second level that is higher than the first level, such as the top of a perimetric wall or the bottom of an opening into an enclosure or cavity. The ramp may be a linearly inclined surface or may be inclined with a varying profile. A varying profile may vary the angle of incline along the ramp. For example, a varying profile may have a greater angle of inclination at one portion of the ramp with respect to another portion of the ramp. More specifically, a varying profile may have a first portion disposed outside of the chamber and a second portion adjacent to the opening, and the first portion may have a steeper incline when compared with the second portion, alternatively the second portion may have a steeper incline when compared with the first portion.

The angle of incline may be, in use, with respect to the ground or the seabed. Alternatively, or additionally, the angle of incline may be, in use, with respect to a horizontal plane and/or with respect to a plane that is perpendicular to a perimetric wall of the chamber.

The ramp may be inclined at an angle of incline. For example, the angle of incline may be between the first portion of the ramp and the second portion of the ramp. The angle of incline may be between 5 and 50 degrees. More specifically, the angle of incline may be between 5 and 50 degrees, between 15 and 50 degrees, between 25 and 50 degrees, or between 35 and 50 degrees. In some examples, the angle of incline does not exceed 45 degrees. In some examples, the angle of incline is at least 30 degrees.

In this way, the ramp can be optimised to maximise the capture rate for scallops. More specifically, the incline of the ramp can be optimised to maximise the capture rate for different types of scallop, such as for example, different sizes of scallop or for scallops at different stages of their development.

The opening may be configured to allow the entry of a scallop. More specifically an opening may be configured to provide an opening with a smallest dimension of at least 4 cm, at least 6 cm, at least 8 Cm or at least 10 cm. An opening with a smallest dimension of at least 6 cm, 8 cm or 10 cm may be sufficient to allow a scallop to proceed through the opening, depending on the minimum stage of development of the scallop intended to be caught by the trap. Alternatively or additionally, the opening may be configured to provide an opening with a largest dimension of at most 40 cm, in particular at most 30 cm, more particularly at most 20 cm, or for example at most 15 cm. A larger opening may facilitate capture of a scallop. A smaller opening may facilitate scallop retention within the trap.

The attractant may be disposed, in use, above the second portion of the ramp and/or above the opening and/or above the chamber. The term “above” in this context is synonymous with “a higher level than”. The attractant may be, but is not necessarily, directly above at least one of the ramps, the opening, and/or the chamber. For example, the attractant may be, in use, above the ramp. Alternatively, for example, the attractant may be, in use, above the ramp but laterally displaced from the ramp.

The attractant may be at least one of an emitter of light, a chemical attractant, or a food source. More specifically, the emitter of light may be one or more electronic lights, such one or more LEDs or lamps. The attractant may be at least one of an emitter of light (or LED) for attracting scallops, a chemical attractant for attracting scallops, or a food source for attracting scallops.

The emitter of light may be configured to emit light in a variety of different colours or wavelengths. For example, the emitter of light may be configured to emit only one, one or more, or more than one, of ultraviolet coloured light, violet coloured light, indigo coloured light, blue coloured light, green coloured light, yellow coloured light, orange coloured light, red coloured light, infrared coloured light, or a specific combination thereof, such as white coloured light. For example, the emitter of light may be configured to emit green coloured light in the absence of any other colour of light, or the emitter of light may be configured to emit blue and yellow (and optionally green) coloured lights in the absence of any other colour of light.

The emitter of light may comprise a continuous or constant emitter of light. Alternatively, or additionally, the emitter of light may comprise an intermittent light, such as, a pulsed, flickering or flashing emitter of light. The intermittent light may have a predetermined pulse rate or frequency of operation. For example, the intermittent light may have a pulse rate or frequency of operation that is below the flicker fusion threshold for a scallop. More specifically, the emitter of light may have a pulse rate or frequency of operation that is below 100 Hz, below 75 Hz, below 50 Hz, below 25 Hz or below 5 Hz.

A duty cycle of the intermittent light may be configured to maximise the number of scallops attracted. For example, the intermittent light may be on for less than a minute and off for at least 30 minutes or alternatively on for a period of between 10 and 20 minutes with an off period of at least 2 hours. The intermittent light may have a duty cycle of below 1%, below 5%, below 10%, below 30% or below 50%.

The emitter of light may be configured to have a single intensity, or may be configured to operate with multiple intensities. For example, the emitter of light may be configured to emit light at a first intensity for a first period of time, and emit light at a second intensity, less than the first intensity, for a second period of time. In particular, the second period of time may be greater than the first period of time. In this way, a bright intense light may attract the attention of the scallops over a brief period of time, and then once their attention has been caught, a lower-level light may be used as an ongoing attractant over a longer period of time, thereby saving energy. For example, the first period of time may be between thirty seconds and two minutes, in particular between forty-five seconds and one-and-a-half minutes, more particularly approximately one minute. Similarly, the second period of time may be between ten minutes and two hours, in particular between 20 minutes and an hour, more particularly approximately 30 minutes.

In some examples, the attractant may be a luminescence-based light, such as a chemiluminescence based light. Electronic lights allow the trap to be more easily maintained by removing the need to frequently top up the attractant. In some examples the attractant may be a chemical attractant, such as pheromones.

A slot or cavity may be formed between the ramp and the chamber. That is to say, the space that is under the ramp, in use, forms a slot or cavity. This slot or cavity may otherwise be referred to as a retention slot or a retention cavity. The retention slot or retention cavity may increase the capture yield or capture retention because, in use, a captured creature becomes stuck under the ramp in said retention slot or cavity when trying to escape and is physically prevented from escaping the trap by the ramp, under which the creature is trapped.

The ramp and/or chamber may comprise holes therein. The ramp and/or chamber may be formed from one or more sheets and/or screens comprising holes. Each sheet and/or screen comprising holes may be a perforated sheet and/or screen. Each sheet and/or screen comprising holes may be a material into which holes are formed. Each sheet and/or screen comprising holes may be formed from a wire mesh. The holes of each sheet and/or screen may be configured to have a largest dimension of less than 6 cm, less than 8 Cm or less than 10 cm. The sheet and/or screen may be made from a variety of materials including netting, plastic, metal, wire, etc.

In this way, the unintentional drift of a scallop trap can be reduced. Moreover, the largest dimension of the holes may be configured such that the trap only retains scallops that are at a minimum stage of development.

The chamber may comprise an additional opening and an additional ramp for directing scallops to the additional opening. The additional ramp may comprise a first portion disposed outside of the chamber and a second portion adjacent to the additional opening. In use, the second portion of the additional ramp may be disposed above the first portion of the additional ramp. Some examples may comprise more than one additional opening, each additional opening being associated with a corresponding additional ramp.

In this way, the capture rate of the trap may be increased by providing more routes into the trap.

The additional opening may be adjacent to, or spaced apart from, the opening. A plurality of additional openings may be provided. Each of the plurality of additional openings may be provided with a corresponding ramp. Alternatively, or additionally, each of a plurality of ramps may be provided with a corresponding opening. A plurality of ramps may be provided with a shared opening.

A chamber may be provided with a plurality of openings. Each opening of the plurality of openings may be provided with a corresponding ramp. The trap may have a square, rectangular or round shape or footprint.

A plurality of chambers, sub-chambers of a chamber, may each be provided with one or more openings. Wherein the openings may have a smallest dimension of at least 4 cm, 6 cm, 8 cm, 10 cm, or 12 cm. Openings of these sizes may be sufficient to admit a creature, such as a scallop, to the trap. The openings may be sized to allow the entry of a creature, such as a scallop, at a specific stage of development as described in relation to the opening herein.

Each opening, each chamber, and/or each sub-chamber may be provided with a respective ramp, wherein each ramp is a ramp as described herein.

Each ramp may comprise a first portion disposed outside of the chamber and a second portion adjacent to a respective opening. In use, the second portion of each ramp may be disposed above the first portion of each ramp.

The scallop trap may also comprise a deflector configured to physically prevent objects that pass over the ramp from bypassing the chamber. More specifically, in some examples, the deflector is configured to, in use, physically prevent objects that pass over the top of the ramp from bypassing, or otherwise avoiding, the chamber. The top of the ramp may be, in use, the highest end of the ramp. Each ramp may have a respective deflector. In some examples, a single deflector may be effective for multiple ramps.

In some examples, a covering may be provided that is spaced apart from the opening of the chamber. However, this covering is not required to prevent the escape of some creatures, such as scallops. In some examples, the scallop trap may have, in use, an open-top. An open-top design allows for the escape of creatures that are strong swimmers, such as fish. Thereby an open-top design provides a trap that can retain a higher yield of scallops and that is less damaging to the eco-system, through the capture of fewer undesirable fish. A deflector may be especially beneficial to an open-top scallop trap.

A funnel arrangement may be provided. The funnel arrangement may comprise a larger opening of the funnel and a smaller opening of the funnel. The funnel may taper from the larger opening down to the smaller opening. The funnel may comprise no openings other than the larger and smaller opening. The funnel may comprise multiple smallest openings that are smaller than the smaller opening. The smaller opening may be configured to open into a sub-chamber within the chamber.

In this way, crustaceans may be caught in the scallop trap in addition to scallops. In addition, the scallops may be retained more securely, which in turn may increase the yield of the trap. In addition, a crustacean may enter through the ramp and then move through the funnel into a chamber and becoming trapped therein.

A funnel arrangement may be provided for directing scallops to the opening of the chamber. The funnel arrangement may comprise the ramp. More specifically, in some examples, the funnel arrangement comprising the ramp is provided for directing creatures into a chamber.

In this way a smaller scallop trap capable of capturing crustaceans may be provided, without the need for an additional or separate funnel. In addition, the scallops may be retained more securely in a more compact trap, which in turn may increase the yield of the trap when compared with the size of the trap.

A deflector may be provided. The deflector may be configured to physically prevent objects that pass over the second portion of the ramp from bypassing the chamber.

In this way, scallops may be captured in a cavity or chamber with, in use, an open top. The deflector physically prevents objects from bypassing the chamber once they have passed over the second portion of the ramp. Thereby, scallop traps in which the entirety of the chamber is disposed, in use, below the second portion of the ramp, can effectively capture scallops.

In this way, smaller trap designs can be provided that use less construction material. Moreover, it may provide more durable designs that are easier to collect trapped scallops from, as fiddly moving parts of the trap can removed and the catch can be recovered by simply inverting the trap. Furthermore, a greater total length of ramp for given design area can be used, which increases capture rate for compact devices.

The ramp may be a perimetral ramp configured to surround the chamber. A deflector may be provided in the centre of the perimetral ramp. The deflector may be configured to physically prevent objects that pass over the second portion of the ramp from bypassing the chamber.

In this way, the scallop capture rate can be maximised for a given size of scallop trap.

The perimetral ramp may have a square, rectangular or round shape or footprint. Alternatively, or additionally, the chamber may comprise the perimetral ramp.

### BRIEF DESCRIPTION OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is a schematic representation of a scallop trap with a single ramp.

FIG. 2 is a cutaway schematic representation of a scallop trap with a single ramp.

FIG. 3 is a cutaway schematic representation of a scallop trap with a single ramp with holes.

FIG. 4 is a cutaway schematic representation of the side view of a scallop trap with a single ramp.

FIG. 5 is a cutaway schematic representation of a scallop trap with a double ramp.

FIG. 6A is a schematic representation of a scallop trap with a single ramp.

FIG. 6B is a schematic representation of the side view of a scallop trap with a single ramp.

FIG. 7A is a schematic representation of a scallop trap with a double ramp.

FIG. 7B is a schematic representation the side view of a scallop trap with a double ramp.

FIG. 8A is a schematic representation of a scallop trap with a perimetral ramp.

FIG. 8B is a schematic representation of the top view of a scallop trap with a perimetral ramp.

FIG. 8C is a cutaway schematic representation of the side view of a scallop trap with a perimetral ramp.

FIG. 9 is a schematic representation of a scallop trap with a ramp and a funnel.

### DETAILED DESCRIPTION

The present invention will be described with respect to certain drawings, but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein. Likewise, method steps described or claimed in a particular sequence may be understood to operate in a different sequence.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other. For instance, wireless connectivity is contemplated.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any one embodiment or aspect of the invention may be combined in any suitable manner with any other particular feature, structure or characteristic of another embodiment or aspect of the invention, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

In the description provided herein the terms “part” and “portion” are used interchangeably herein.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

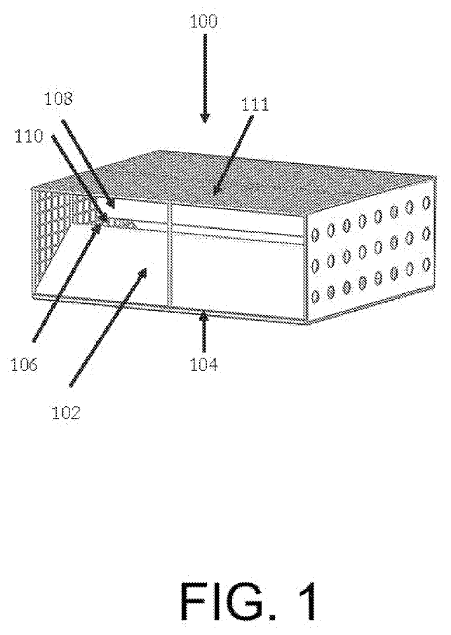

FIG. 1 shows a schematic representation of a scallop trap 100 with a single ramp 102 in accordance with an arrangement. The scallop trap 100 has a ramp 102 and a chamber with an opening 110.

The ramp 102 has a first part 104 outside of the chamber and a second part 106 adjacent to the opening 110. The ramp is configured to direct moving objects towards the opening 110. For example, a creature, or more specifically a scallop, is directed up the ramp 102 from the first part 104 to the second part 106, where in use the second part 106 is disposed above the first part 104. In this way, the ramp 102 facilitates the movement of an object or creature to the opening 110. A scallop may be an object or creature in this example. The opening 110 may be, in use, positioned at a height above the ground. For example, at a height above the ground that would be difficult for a creature to reach by its own motion. In this example, the ground may be the seabed.

The scallop trap may also include a deflector 108. The deflector 108 may be configured to physically prevent objects, or more specifically scallops, passing through it.

The scallop trap 100 includes an attractant.

In some examples, a covering 111 may be provided that is aligned to and/or spaced apart from the opening 110. Such a covering may prevent other creatures from feeding on the captured or trapped creatures. Alternatively, or additionally, such a covering may prevent creatures, such as scallops from escaping from smaller traps.

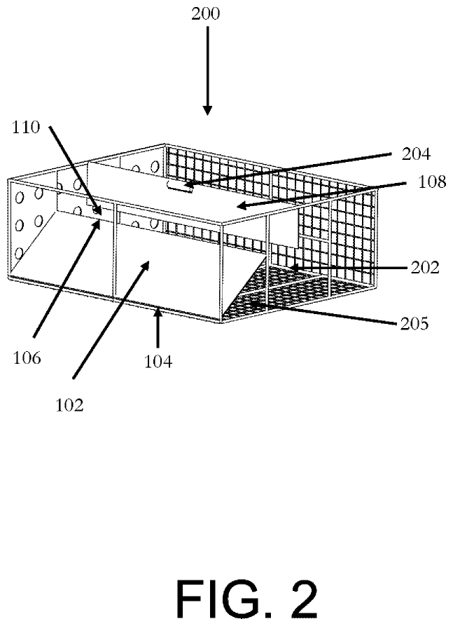

FIG. 2 is a cutaway schematic representation of a scallop trap 200 with a single ramp 102 in accordance with an arrangement. The scallop trap 200 includes an attractant 204. The attractant 204 may be configured to encourage an object or creature, such as a scallop, up the ramp 102. The attractant 204 may be disposed, in use, above the second portion of the ramp 106. Alternatively, or additionally, the attractant 204 may be disposed, in use, above the second portion of the ramp 106. The attractant 204 may be, for example, an emitter of light, such as an LED.

The attractant 204 acts to encourage a creature, such as a scallop, to a trap such as trap 200. Moreover, the attractant 204 acts to encourage a creature, such as a scallop, up the ramp 102 to cause the creature to enter the trap 200.

Scallops move by opening and closing their shell using a pulsing action to create jets of water. These jets of water provide propulsion. Scallops will be attracted by the attractant 204 and will therefore swim up the ramp 102 and drop into the chamber 202. Once in the chamber 202 of the trap 200 it is difficult for the scallop to escape as overcoming the second part of the ramp 106 before the first part of the ramp 104 requires a much more powerful jet of water than overcoming the first part of the 104 before the second part of the ramp 106. In addition, the ramp opening forms a narrow slot or cavity between the ramp and the chamber, thereby causing the scallop to become caught under the ramp 102. The ramp 102 may be configured such that a creature, e.g. a scallop, is caught in a slot or cavity under the ramp 102, rather than being contained only by the height of the ramp 102. The slot or cavity between the ramp and the chamber may be a retention slot or a retention cavity. The retention slot or retention cavity may increase the capture yield or capture retention.

The deflector 108 is a physical barrier. This physical barrier aids in preventing escape of the captured creatures. For example, a creature that uses jets of water to move may be deflected by this physical barrier on contact. This deflector 108, or physical barrier, may increase the retention of captured creatures. The deflector 108 may be configured to align with the opening 110 or the ramp 102. Aligning the deflector with the opening 110 or ramp 102 may prevent creatures from reaching the ramp 102 or opening 110 from inside the chamber 202.

A retention cavity 205 may be formed between the ramp 102 and the chamber 202.

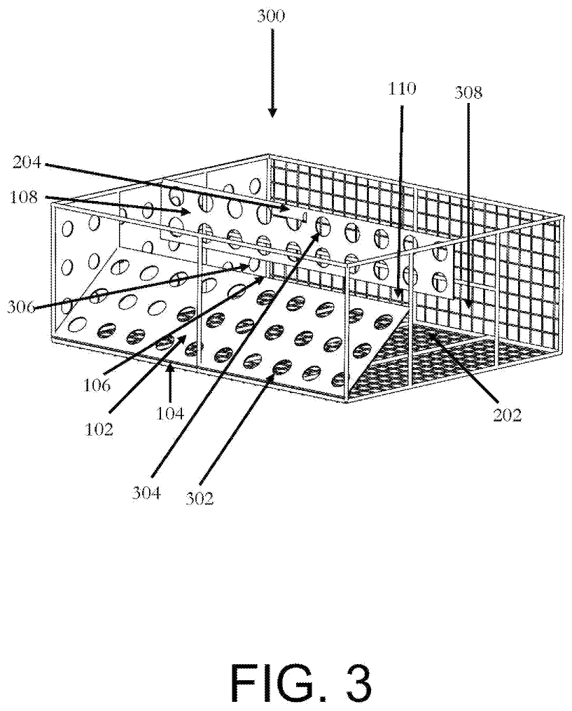

FIG. 3 is a cutaway schematic representation of a scallop trap 300 with a single ramp 102 with holes 302 in accordance with an arrangement. Each component of the trap can be formed with or without holes 302, 304, 306, 308. These holes 302, 304, 306, 308 may otherwise be described as flow holes 302, 304, 306, 308. Holes 302, 304, 306, 308 or flow holes 302, 304, 306, 308 may reduce the drift of the trap 300 when the trap 300 is underwater, by reducing the effect on the trap's position of water movement through and around the trap 300. More specifically, the ramp 102 may be constructed from a sheet comprising holes 302. The deflector 108 may be constructed from a sheet comprising holes 304. Alternatively, or additionally, the chamber 202 may be constructed from one or more sheets comprising holes 306, 308. The sheet or sheets comprising holes may be, for example, plastic or metal sheets comprising holes.

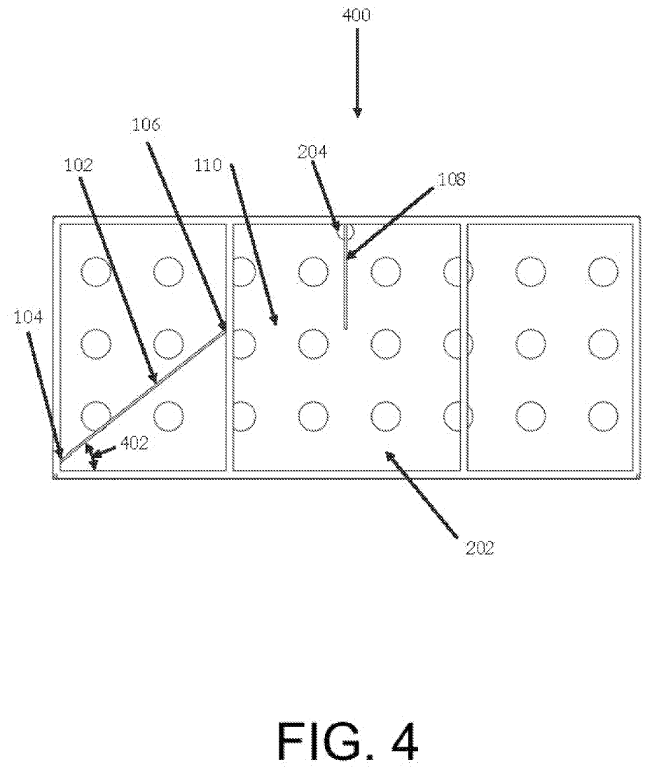

FIG. 4 is a cutaway schematic representation of the side view of a scallop trap 400 with a single ramp 102 in accordance with an arrangement. The side view shows that, in some examples, the ramp 102 may be inclined at an angle of incline 402. The angle of incline 402 may be the angle, or the mean average angle, of incline between the first part 104 of the ramp 102 and the second part 106 of the ramp 102. Alternatively, or additionally, the angle of incline 402 may be the angle, or the mean average angle, of the ramp with respect to, in use, the bottom of the chamber. Alternatively, or additionally, the angle of incline 402 may be the angle, or the mean average angle, of the ramp with respect to the seabed, the ground or any other surface on which the scallop trap 400 is disposed.

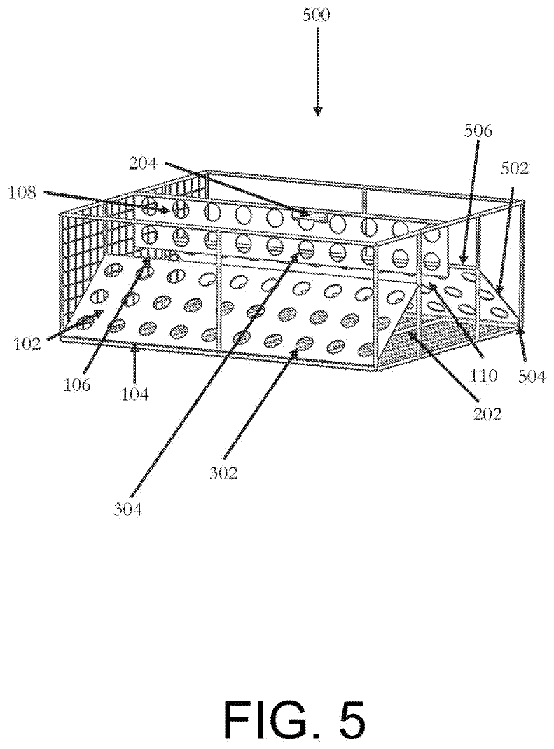

FIG. 5 is a cutaway schematic representation of a scallop trap 500 with a double ramp 102, 502 in accordance with an arrangement. The additional ramp 502 may have one or more of the properties described with respect to the ramp 102. That is to say, the additional ramp 502 may have any of the properties described with regard to the ramp 102. In some examples, the additional ramp 502 is configured to direct creatures, such as scallops, into the same chamber 202 as the ramp 102. Each ramp 102, 502 may be configured to utilise a single deflector. In some examples, each ramp 102, 502 may be provided with a deflector.

A scallop trap 500 is not limited to two ramps 102, 502. For example, a scallop trap 500 may comprise one ramp, one or more ramps, two ramps, or a plurality of ramps. Each ramp 102, 502 may be provided with a corresponding opening. In some examples, each ramp 102, 502 is directed toward a singular shared opening. In some examples, the chamber comprises an additional opening and an additional ramp. Each additional ramp may be for directing creatures, such as scallops, to a corresponding additional opening or to a singular shared opening. Each additional ramp 502 comprises a first portion 504 disposed outside of the chamber 202, or disposed outside of all of the chambers 202 of the scallop trap 500, and a second portion 506 adjacent to the singular shared opening 110, or the corresponding opening 110. In use, the second portion 506 of the, or each, additional ramp 502 is disposed above the first portion 504 of the, or each, additional ramp 502.

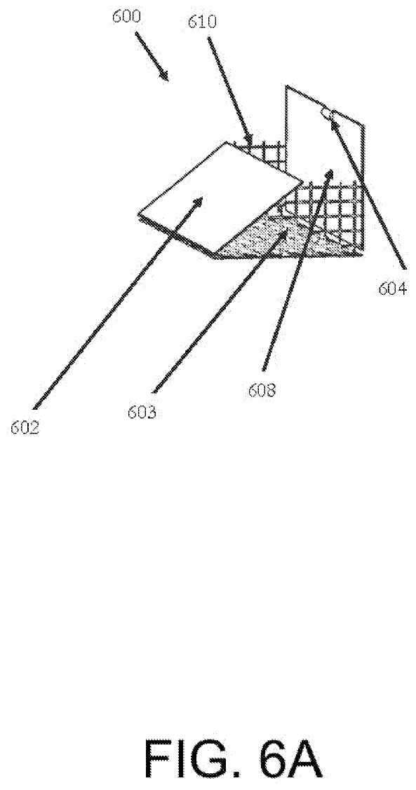

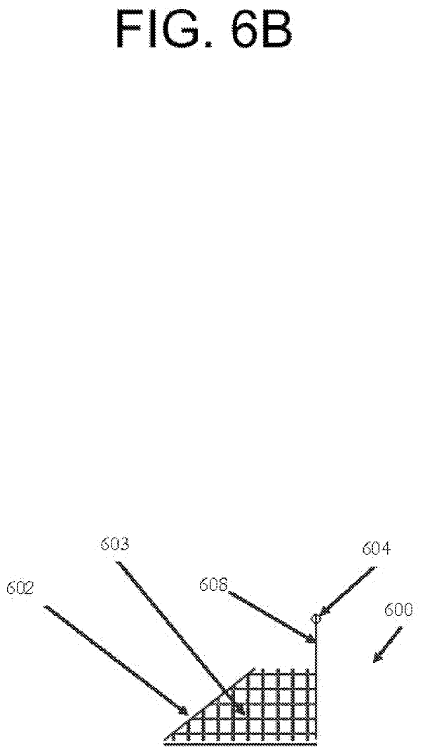

FIG. 6A is a schematic representation of a scallop trap 600 with a single ramp 602 in accordance with an arrangement. FIG. 6B is a schematic representation of the side view of the scallop trap 600 with a single ramp 602 in accordance with an arrangement. FIGS. 6A and 6B show a scallop trap 600 which includes a chamber 603, a ramp 602, a deflector 608 and an attractant 604. The chamber 603 comprises an opening 608. The opening 610 is suitable for allowing objects or creatures, such as scallops, to enter the chamber 603. The ramp 602, allows objects or creatures, such as scallops, to be directed toward the opening 610. The ramp 602 comprises a first portion disposed outside of the chamber and a second portion adjacent to the opening 610. In use, the second portion of the ramp 602 is disposed above the first portion of the ramp 602.

The attractant 604 is disposed, in use, above the ramp 602. The attractant 604 may be, for example, a light or more specifically an LED.

The ramp 602 is inclined at an angle of incline. The angle of incline may be indicative of the steepness of the ramp 602. The angle of incline may be configured to capture specific objects or creatures. More specifically, the angle of incline may be configured to capture creatures, such as scallops, at predetermined stages of development. For example, steeper ramps or ramps with a larger angle of incline may prevent the capture of infant scallops. The ramp may be configured at an angle of incline, for example, between 5 and 50 degrees.

The scallop trap 600 also comprises a deflector 608 configured to physically prevent objects that pass over the ramp 602 from bypassing the chamber 603. More specifically, in some examples, the deflector 608 is configured to, in use, physically prevent objects that pass over the top of the ramp 602 from bypassing, or otherwise avoiding, the chamber 603. The top of the ramp 602 may be, in use, the highest end of the ramp 602.

In some examples, a covering may be provided that is spaced apart from the opening 610 of the chamber 603. However, this covering is not required to prevent the escape of some creatures, such as scallops. In some examples, the scallop trap 600 may have, in use, an open-top. An open-top design, as shown in FIGS. 6A and 6B, allows for the escape of creatures that are strong swimmers, such as fish. Thereby an open-top design provides a trap that can retain a higher yield of scallops and that is less damaging to the eco-system.

A deflector 608 may be especially beneficial to an open-top scallop trap. In some examples, the size of a trap, or an open top trap, can be reduced through the use of a deflector configured to physically prevent objects that pass over the ramp 602 from bypassing the chamber 603.

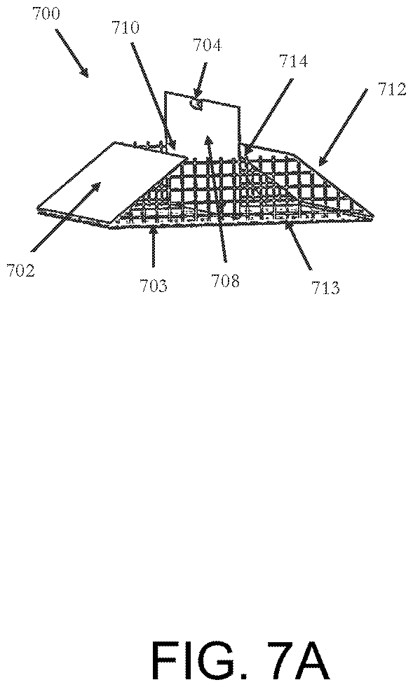

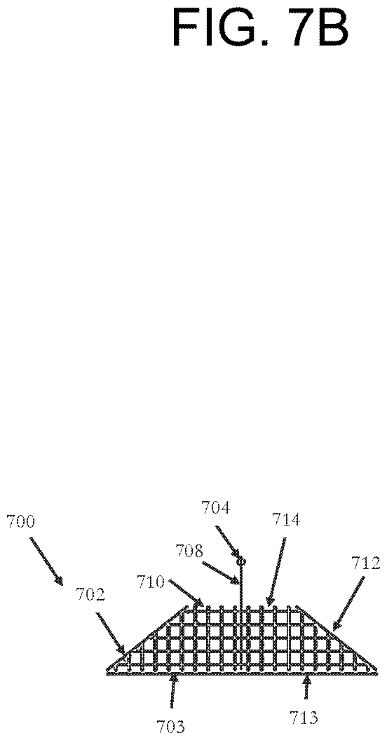

FIG. 7A is a schematic representation of a scallop trap 700 with a double ramp 702, 712 in accordance with an arrangement. FIG. 7B is a schematic representation the side view of a scallop trap 700 with a double ramp 702, 712 in accordance with an arrangement. The scallop trap 700 shown in FIGS. 7A and 7B is an open-top trap as described in relation to FIGS. 6A and 6B.

FIGS. 7A and 7B show a scallop trap 700 which includes a chamber 703, 713 a ramp 702, 712, a deflector 708 and an attractant 704. The chamber 703,713 comprises an opening 710, 714. The opening 710,714 is suitable for allowing objects or creatures, such as scallops, to enter the chamber 703, 713. The ramp 702, 712 allows objects or creatures, such as scallops, to be directed toward the opening 710, 714.

The chamber depicted in this FIG. comprises an additional opening 714, 710 and an additional ramp 712, 702 for directing scallops to the additional opening 714, 710, the additional ramp 712, 702 having a first portion disposed outside of the chamber and a second portion adjacent to the additional opening, and in use the second portion of the additional ramp 712, 702 is disposed above the first portion of the additional ramp 712, 702.

The additional opening 714, 710 may be adjacent to, or spaced apart from the opening 710, 714. A plurality of additional openings 714, 710 may be provided. Each of the plurality of additional openings 714, 710 may be provided with a corresponding ramp 702, 712. Alternatively, or additionally, each of a plurality of ramps may be provided with a corresponding opening. A plurality of ramps may be provided with a shared opening.

A chamber 713, 703 may be provided with a plurality of openings. Each opening of the plurality of openings may be provided with a corresponding ramp.

A plurality of chambers, sub-chambers of a chamber, may each be provided with one or more openings. Wherein the openings are sized to allow the entry of a creature, such as a scallop. Each opening, each chamber, and/or each sub-chamber may be provided with a ramp, wherein each ramp is a ramp as described herein. As shown in FIGS. 7A and 7B, the each of 703 and 713 may be referred to as a chamber. Alternatively, each of 703 and 713 may be referred to as a sub-chamber of a chamber formed by the combination of 703 and 713.

In some examples, each ramp 702, 712 comprises a first portion disposed outside of the chamber and a second portion adjacent to the opening 710. In use, the second portion of the ramp 702 is disposed above the first portion of the ramp 702.

The attractant 704 may be disposed, in use, above the ramp 702. The attractant may be, for example, a light or more specifically an LED.

The scallop trap 700 also comprises a deflector 708 configured to physically prevent objects that pass over the ramp 702, 712 from bypassing the chamber 703. More specifically, in some examples, the deflector 708 is configured to, in use, physically prevent objects that pass over the top of the ramp 702, 712 from bypassing, or otherwise avoiding, the chamber 703, 713. The top of ramp 702, 712 may be, in use, the highest end of the ramp 702.

In some examples, a covering may be provided that is spaced apart from the opening 710 of the chamber 703. However, this covering is not required to prevent the escape of some creatures, such as scallops. In some examples, the scallop trap 700 may have, in use, an open-top. An open-top design, as shown in FIGS. 7A and 7B, allows for the escape of creatures that are strong swimmers, such as fish. Thereby an open-top design provides a trap that can retain a higher yield of scallops and that is less damaging to the eco-system. A deflector 708 may be especially beneficial to an open-top scallop trap.

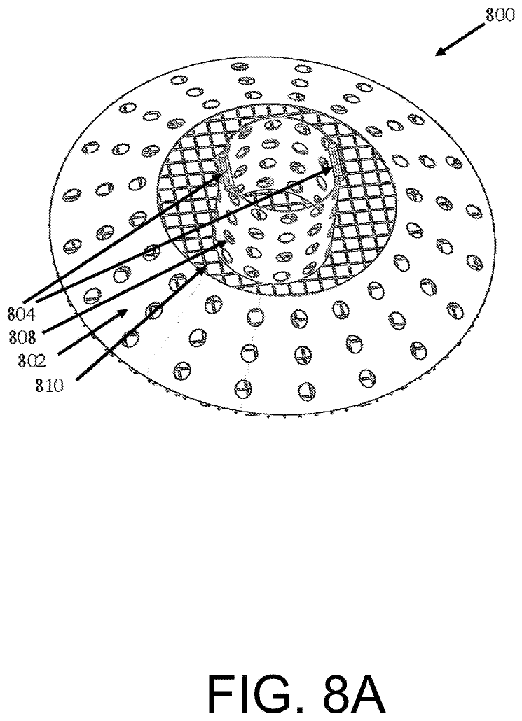

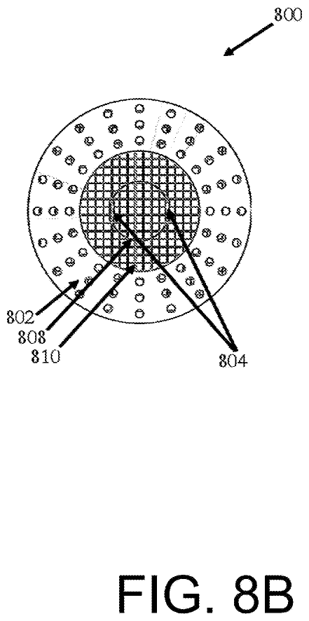

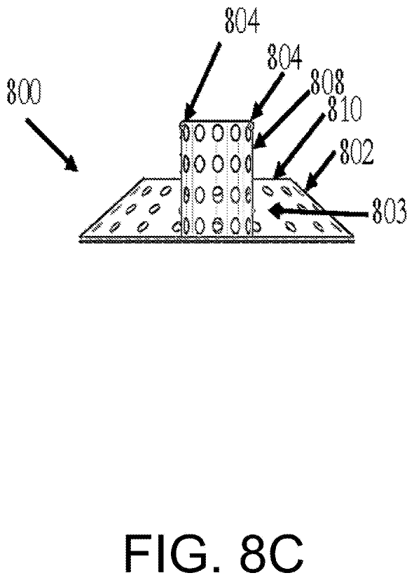

FIG. 8A is a schematic representation of a scallop trap 800 with a perimetral ramp 802 in accordance with an arrangement. FIG. 8B is a schematic representation of the top view of a scallop trap 800 with a perimetral ramp 802 in accordance with an arrangement. FIG. 8C is a cutaway schematic representation of the side view of a scallop trap 800 with a perimetral ramp 802 in accordance with an arrangement.

In each of the representations of the scallop trap 800 shown in FIGS. 8A, 8B, and 8C the scallop trap 800 comprises a chamber 803 with an opening 810, a perimetral ramp 802, an attractant 804 and a deflector 808. In this example, the perimetral ramp 802 is a perimetral ramp 802 configured to surround the chamber 802.

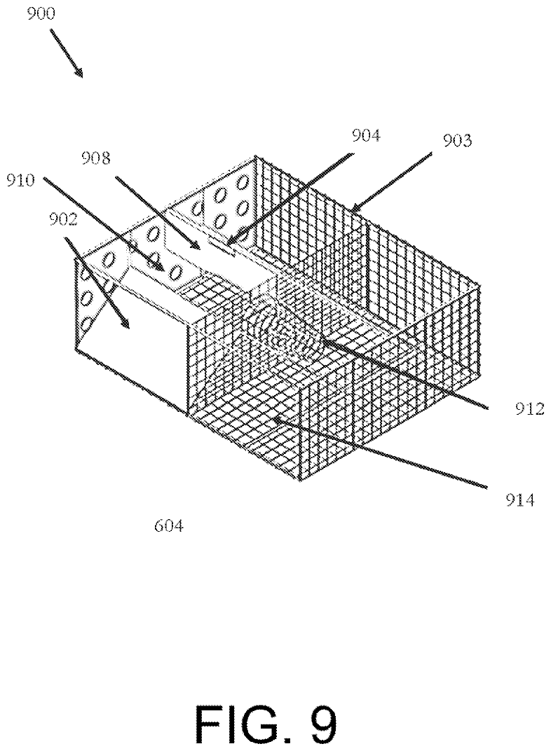

FIG. 9 is a schematic representation of a scallop trap 900 with a ramp 902 and a funnel 912 in accordance with an arrangement. The scallop trap 900 having a chamber 903, a ramp 902, an attractant 904, a deflector 908 and a funnel arrangement 912. The chamber 903 having an opening 910. The ramp 902 having a first portion disposed outside of the chamber and a second portion adjacent to the opening, and in use the second portion is disposed above the first portion. The ramp is for directing scallops to the opening 910. The attractant 904, in this example, is disposed, in use, above the second portion of the ramp 902.

The funnel arrangement 912 is provided with a larger opening of the funnel 912 and a smaller opening of the funnel 912. The smaller opening is configured to open into a sub-chamber 914 within the chamber 903.

1. A scallop trap comprising:
a chamber having an open-top comprising an opening;
a ramp, for directing scallops to the opening, having a first portion disposed outside of the chamber and a second portion adjacent to the opening, and in use the second portion is disposed above the first portion; and
an attractant disposed, in use, above the second portion of the ramp.

2. The scallop trap of claim 1, wherein the ramp is inclined at an angle of incline between the first portion and the second portion, and wherein the angle of incline is between 5 and 50 degrees.

3. The scallop trap of claim 1, wherein the ramp is constructed from a sheet comprising holes.

4. The scallop trap of claim 1, wherein the chamber comprises an additional opening and an additional ramp for directing scallops to the additional opening, the additional ramp having a first portion disposed outside of the chamber and a second portion adjacent to the additional opening, and in use the second portion of the additional ramp is disposed above the first portion of the additional ramp.

5. The scallop trap of claim 1, wherein a funnel arrangement is provided with a larger opening of the funnel and a smaller opening of the funnel, and wherein the smaller opening is configured to open into a sub-chamber within the chamber.

6. The scallop trap of claim 1, wherein a funnel arrangement is provided, for directing scallops to the opening of the chamber and the funnel arrangement comprises the ramp.

7. The scallop trap of claim 1, wherein the attractant emits light.

8. The scallop trap of claim 7, wherein the attractant is configured to emit light at a first intensity for a first period of time, and emit light at a second intensity, less than the first intensity, for a second period of time, greater than the first period of time.

9. The scallop trap of claim 1, comprising a deflector configured to physically prevent objects that pass over the second portion of the ramp from bypassing the chamber.

10. The scallop trap of claim 9, wherein the ramp is a perimetral ramp configured to surround the chamber.
